(19) United States
(12) Patent Application Publication
(10) Pub. No.: US 2009/0021037 A1
(43) Pub. Date: Jan. 22, 2009

(54) STOWAGE CONTAINER ARRANGEMENT

(75) Inventors: Mike Smetham, Wittingen (DE); Carsten Espe, Solbach/Sieg (DE)

Correspondence Address: BARNES & THORNBURG LLP, 11 SOUTH MERIDIAN, INDIANAPOLIS, IN, 46204, US

(73) Assignee: Faurecia Innenraum Systeme GmbH

(21) Appl. No.: 11/912,036

(22) PCT Filed: Apr. 25, 2006
(86) PCT No.: PCT/EP2006/004229

§ 371 Date: Aug. 13, 2008

(30) Foreign Application Priority Data
Apr. 28, 2005 (DE) 10 2005 020 700.6

(51) Int. Cl. B60R 7/04

(52) U.S. Cl. 296/37.13

(57) ABSTRACT

The invention relates to a stowage container arrangement (1) which is suitable in particular for installation in a door lining (14) of a door (13) of a vehicle.

The stowage container arrangement (1) contains a receiving shape (2) and a stowage container (3) which can be removed from the receiving shape (2) and has a visible-side opening (4). According to the invention, the receiving shape (2) has an undercut (5) and a recess (6). The stowage container (3) engages by its outer contour (7) at least partially into the undercut (5). Furthermore, the stowage container (3) has a manually actuatable bending spring (8) with a catching lug (9), the catching lug (9) of the bending spring (8) engaging in the recess (6) of the receiving shape (2).

The invention produces a constructionally simple stowage container arrangement with a securely retained, removable stowage container which can be used in many places.

The invention relates to a stowage container arrangement which is suitable in particular for installation in a door lining of a vehicle door.

It is known to provide stowage containers in the interior of a vehicle. Stowage containers are generally found in doors, between the seats, in the instrument panel or even on the rear side of the front seats or in the region of the column inner lining.

Stowage containers have the task of receiving various types of objects, such as e.g. maps, vehicle sponges, natural produce but also litter, such as e.g. the remains of packaging or food.

It is likewise known to configure stowage containers as separate components which can be removed from a receiving shape.

Thus a stowage container is disclosed in DE 199 58 524 A1, which can be removed from a receiving shape after fixing means have been unlocked manually. The stowage container contains stowage compartments with openings in which objects can be placed. The stowage container is disposed parallel next to a vehicle seat of an automotive vehicle.

A disadvantage of this just-mentioned stowage container is the complex construction and in particular the complex locking mechanism, as a result of which the use of such a stowage container at places in which in particular space if restricted, such as e.g. in a side door, is not sensible.

It is now the object of the present invention to produce a stowage container arrangement having a stowage container and a receiving shape, the stowage container being able to be removed from the receiving shape or inserted into the receiving shape in a simple manner and which is retained securely by the receiving shape and is protected against improper removal, and stowage container and receiving shape having a simple construction and hence the stowage container being suitable in particular for accommodation in a side door of an automotive vehicle.

This object is achieved by a stowage container arrangement according to claim 1.

As a result of the fact that the receiving shape has an undercut and a recess, and the stowage container engages by its outer contour at least partially into the undercut, and the stowage container has a manually actuatable bending spring with a catching lug and the catching lug of the bending spring engages in the recess of the receiving shape, a stowage container arrangement is produced in which the stowage container is retained securely in the inserted state but can be removed rapidly from the receiving shape. As a result of the simple construction, it is possible in particular to accommodate the stowage container arrangement even in restricted spaces, in particular in a door of an automotive vehicle.

The stowage container is fixed in the receiving shape by means of a lock which is produced by a bending spring with a catching lug and a recess. In the inserted state, the catching lug engages in the recess. By manually raising the bending spring, this lock can be released.

The recess can be formed for example by an undercut. A suitable undercut can be replaced for example by a rib or a projection.

The lock is advantageously self-positioning. This is achieved for example in that the catching lug has a wedge-shaped configuration and hence, during insertion of the stowage container into the receiving shape, locks automatically without actuation of the bending spring.

Secure storage of the stowage container inserted into the receiving shape is ensured by undercut and lock. The stowage container is fixed in the receiving shape by the lock. As a result of the fact that the stowage container engages by its outer contour into the undercut of the receiving shape, additional stabilisation of the stowage container in the supporting shape is achieved. The undercut can hereby be configured in different ways, for example as a groove.

Furthermore, the shaping of the receiving shape can also be used to stabilise the position of the stowage container. The receiving shape is preferably configured as a hollow so that the stowage container can be removed from the receiving shape only in one direction.

Advantageous developments of the invention are described in the dependent claims.

An advantageous development of the invention is that the receiving shape has, in its edge region, a projection by means of which the undercut is formed.

A further advantageous development of the invention is that the upper edge of the projection, by means of which the undercut is occluded, extends in a straight line.

A further advantageous development of the invention is that undercut and recess of the receiving shape are disposed in two oppositely-situated edge regions of the receiving shape.

As a result of the fact that undercut and recess of the receiving shape are disposed in two oppositely-situated edge regions of the receiving shape, the stowage container performs a pivoting movement during release of the lock and removal of the stowage container. The axis of this pivoting movement is defined by the engagement of the outer contour of the stowage container in the undercut. This pivoting movement is possible in particular in that the upper edge of the projection, by means of which the undercut is occluded, extends in a straight line.

A further advantageous development of the invention is that stowage container and receiving shape form a form-fit.

On the one hand, storage of the stowage container in the receiving shape is consequently made stable and, on the other hand, the “free” space of the receiving shape, in particular if the latter is configured as a hollow, is used in this way as a stowage space for the stowage container.

A further advantageous development of the invention is that the side of the stowage container which is orientated towards the receiving shape is curved.

A curve is advantageous in particular in the case where the stowage container is situated in a form-fit in a hollow-shaped receiving shape and a pivot axis is defined by the undercut: the curve in this case is configured perpendicular to the pivot axis. The curve is necessary in order that the stowage container does not jam with the receiving shape during pivoting about the pivot axis.

Furthermore, a particularly rigid construction of this stowage container arrangement can be achieved in particular by a curve. Consequently, a so-called “pelvis pusher” function can be ensured when integrated in a vehicle door: in the case of side impact on the vehicle door, the vehicle door would push an occupant into the vehicle interior because of the rigidity thereof and protect the latter hence from glass or metal parts.

In principle, also other shapes, for example rectangular shapes, of the stowage container are however possible. The receiving shape must be correspondingly adapted to enable removal of the stowage container.

A further advantageous development of the invention is that the bending spring is disposed within the stowage container and consequently engages through an opening in the rear side of the stowage container into the recess of the receiving shape.

In this way, the bending spring is protected against unintentional release. The lock is also not visible from outside, which has optical advantages, on the one hand, and, on the other hand, also has safety-technical advantages since the lock does not appear on the visible-side surface of the stowage container.

A further advantageous development of the invention is that the bending spring is configured as an under-grip handle which is accessible via the visible-side opening of the stowage container.

In this way, the bending spring is not covered or soiled by rubbish or other objects which are placed in the stowage container since the bending spring is situated above the visible-side opening of the stowage container.

A further advantageous development of the invention is that the outer edges of the receiving shape and of the stowage container terminate at the same height on the visible side.

A further advantageous development of the invention is that the visible-side surface of the stowage container is flat.

By reducing edges and as a result of the flat configuration of the stowage container, the places at which passengers can suffer impact and injure themselves are minimised.

Furthermore, the invention discloses a vehicle door containing a stowage container arrangement according to the invention, the receiving shape being formed by a recess of a door inner lining associated with the vehicle door.

The stowage container arrangement according to the invention can likewise be integrated in a central panel or a side lining.

The invention is now explained with reference to several Figures. There are thereby shown:

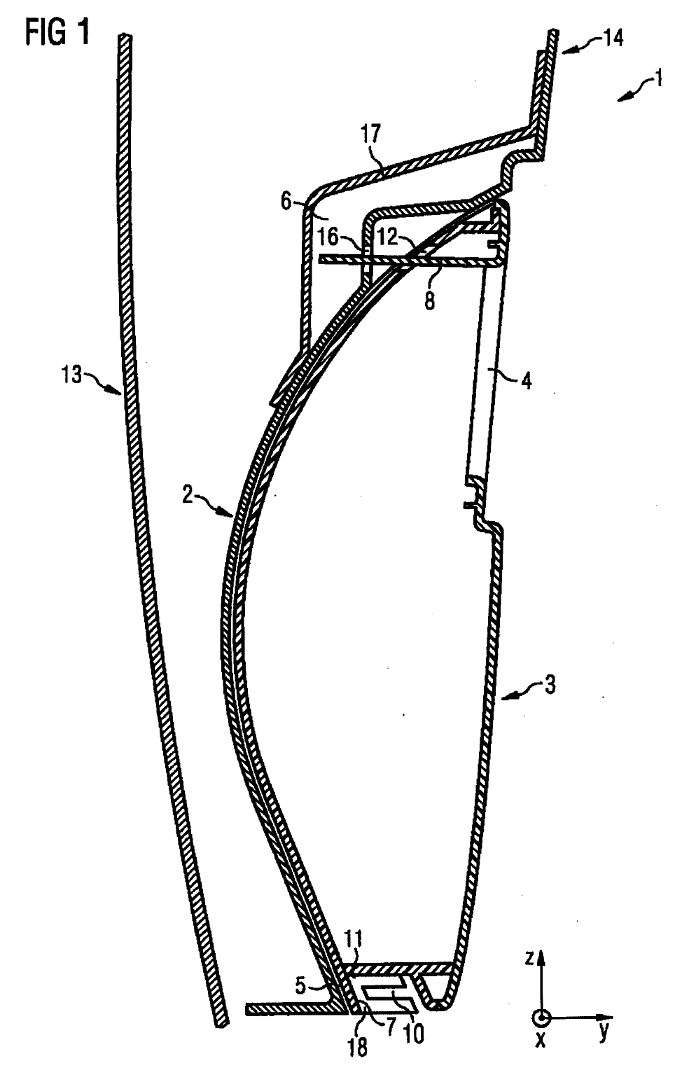

FIG. 1 a cross-section of a stowage container arrangement according to the invention incorporated in a side door of a vehicle,

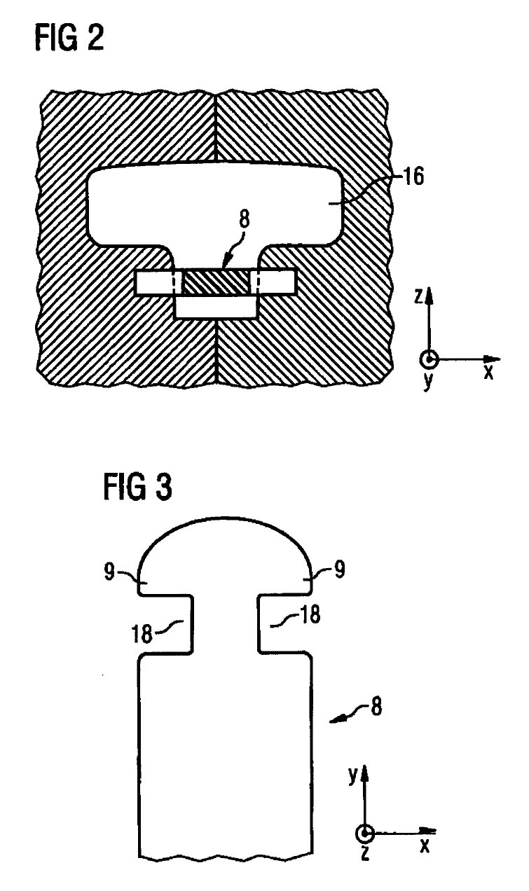

FIG. 2 and FIG. 3 a lock arrangement of the stowage container arrangement according to the invention,

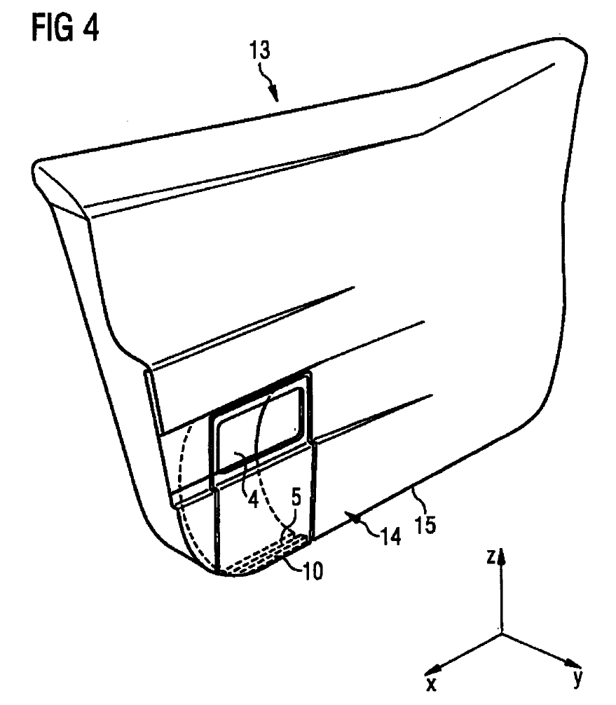

FIG. 4 a side view of the stowage container arrangement according to the invention incorporated in a side door of a vehicle.

FIG. 1 shows a cross-section of a stowage container arrangement 1 according to the invention incorporated in a side door 13 of a vehicle.

The stowage container arrangement 1 contains a receiving shape 2 and a stowage container 3 which is inserted into the receiving shape 2.

The receiving shape 2 is formed by a door inner lining 14 of a vehicle door 13 (in this respect see also FIG. 4). It has the shape of a hollow (see also FIG. 4). The hollow is curved in the z-y plane. The side walls of the hollow are formed by two parallel surfaces situated in the z-y plane.

In its upper end region, the receiving shape has a recess 6. The recess 6 is formed by an additional wall 17 which is situated in the upper region of the hollow and is disposed within the vehicle door behind the hollow of the receiving shape 2. This additional wall 17 can be included in a map pocket rear wall.

The recess 6 is accessible via an opening 16 in the hollow of the receiving shape 2. In this region, the receiving shape does not follow the line of the curve but is only bent upwards in the z-direction, then bent in the y-direction and then follows again the line of the curve. The opening 16 is situated on the stretch between the first and the second bending point, i.e. is orientated in the y-direction.

In the lower edge region, the receiving shape 2 has a projection 10. The projection extends in a straight line in the x-direction and has the shape of an open U-shaped beam, the opening being orientated in the y-direction. The lower edge 18 of the projection 10 thereby teminates with the lower edge of the door lining.

The projection 10 is mounted in front of the line of the curve of the receiving shape 2 for instance in the y-direction. As a result of this mounting at the front, a groove-like undercut 5 is formed which is sealed by the upper edge 11 and the lower edge 18 of the projection 10.

The projection 10 is connected to the door lining in its extension in the x-direction.

The stowage container 3 is adapted at the rear side to the shape of the receiving shape 2, hence the rear side is curved. On the visible side, the stowage container 3 has a smooth surface which is constructed from two surfaces which are offset slightly, approx. above the central height of the stowage container 3 in the y-direction and are situated in the x-z plane.

In the upper third, the stowage container 3 has a visible-side rectangular opening 4 through which the stowage container can be filled or emptied.

In the upper edge region, the stowage container 3 has a bending spring 8 with two catching lugs 9 (not visible in this representation). The bending spring is formed in this embodiment by a lengthened portion of the front which forms the visible-side surface and is situated above the opening 4. At the end of the lengthened portion there are two oppositely-situated notches, by means of which two catching lugs 9 are formed.

The lengthened part bends at the upper edge of the opening 4 inwardly at right angles. Through an opening 12 in the rear wall of the stowage container 3 and through the opening 16 of the receiving shape 2, the bending spring 8 engages in the recess 6, as a result of which a lock is produced (for details see FIG. 2 and FIG. 3 with corresponding description). By raising the bending spring, this lock is releasable.

The bending spring 8 is hence disposed within the stowage container 2. In the present form, it is configured as an under-grip handle. The under-grip handle is accessible via the visible-side opening 4 of the stowage container 3.

The stowage container is situated in a form-fit in the hollow formed by the receiving shape 2. The underside of the stowage container 3 thereby lies flat on the projection 10 of the receiving shape 2 which is mounted in front. The contour of the stowage container extends beyond the projection 10 up to the lower edge of the door lining 14 so that the stowage container 3 covers the projection 10 on the visible side.

Furthermore, the outer contour of the stowage container 3 which is orientated towards the receiving shape 2 has a web 7 in the lower edge region. The web 7 engages in the undercut 5 of the receiving shape 2 which is formed by the beam 10 mounted at the front.

The stowage container 3 comprises only two components. Both components were formed in an injection moulding process and then were welded together subsequently. Polypropylene was used as material.

If the stowage container 3 is intended to be removed, the lock is released by raising the bending spring 8. By pulling the stowage container 3 in the x-direction, the stowage container 3 pivots forwards about the pivot axis defined by the projection 10.

As a result of the curved shape of the stowage container 3 and receiving shape 2, pivoting forwards is not impeded.

By pivoting forwards, the web 7 is partially pulled out of the undercut 5. From a tilting angle of approx. 20°, the stowage container can be pulled away upwards and hence removed from the receiving shape 2.

FIG. 2 and FIG. 3 show the lock of the stowage container arrangement 1. In FIG. 2, the bending spring 8 which engages through the opening 16 in the hollow of the receiving shape 2 into the recess 6 of the receiving shape 2 is represented. In FIG. 3, the front part of the bending spring 8 is represented.

The spring 8 has the shape of an oblong (y-direction), wide (x-direction) and flat (z-direction) leaf. At its end, the shape of the bending spring 8 resembles that of a mushroom: the end of the spring 8 is rounded-off and, in front of the rounded-off end, there are two oppositely-situated notches 18. Two oppositely-situated catching lugs 9 are provided by this shape.

As FIG. 2 shows, the opening 16 of the receiving shape 2 has a T-shape in the x-z plane. The width of the opening is large enough that the bending spring can be pushed with sufficient clearance by its end through the above-situated, wide region of the opening 16 (this region would be the transverse beam of the T analogously with the above).

In the locked-in state, the end of the bending spring is situated in the lower region of the opening 16. Entry of the bending spring into this lower region of the opening 16 is possible only with the narrow region of the bending spring 8 produced by the notches 18. In this state, the catching lugs 9 engage behind the wall of the hollow of the receiving shape 2.

Unlocking of the stowage container 3 is achieved by raising the bending spring 8. The bending spring 8 must be raised so far that the catching lugs 8 no longer engage behind the wall of the hollow of the receiving shape 2.

FIG. 4 shows a side view of the stowage container arrangement 1 according to the invention incorporated in the side door 13 of a vehicle.

As shown in the Figure, the visible-side surface is flush with the surrounding region of the door inner lining 14. The lower edge of the door inner lining 15 is continued by the lower edge of the stowage container 3 so that no interfering edges are present here either.

The shape of the receiving shape 2, and also of the undercut 5 and the projection 10, is indicated in broken lines. As can be detected in the Figure, the width (in the x-direction) of the projection 10 does not correspond to the width of the hollow of the receiving shape 2. This is due to the fact that the edge of the vehicle door 13 in the region of which the stowage container arrangement is disposed is bent. The shape of the receiving shape 2 and of the stowage container 3 is correspondingly adapted, also the width of the projection 10 inter alia is shortened.

1. A stowage container arrangement for the interior of a vehicle, containing a receiving shape and a stowage container which can be removed from the receiving shape and which has a visible side opening wherein the receiving shape has an undercut and a recess, and the stowage container engages by its outer contour at least partially into the undercut, and the stowage container has a manually actuatable bending spring with a catching lug and the catching lug of the bending spring engages in the recess of the receiving shape.

2. The stowage container arrangement according to claim 1 wherein the receiving shape has an edge region, and, in its edge region, a projection forming the undercut.

3. The stowage container arrangement according to claim 2 wherein an upper edge of the projection which occludes the undercut extends in a straight line.

4. The stowage container arrangement according to claim 1 wherein the undercut and the recess of the receiving shape are disposed in two oppositely-situated edge regions of the receiving shape.

5. The stowage container arrangement according to claim 1 wherein the stowage container and receiving shape form a form-fit.

6. The stowage container arrangement according to claim 1 wherein a side of the stowage container which is oriented towards the receiving shape is curved.

7. The stowage container arrangement according to claim 1 wherein the bending spring is disposed within the stowage container and engages through an opening in a rear side of the stowage container into the recess of the receiving shape.

8. The stowage container arrangement according to claim 7 wherein the bending spring is configured as an under-grip handle which is accessible via the visible-side opening of the stowage container.

9. The stowage container arrangement according to claim 1 wherein the receiving shape and the stowage container include outer edges, and the outer edges of the receiving shape and of the stowage container terminate at the same height on the visible side.

10. The stowage container arrangement according to claim 1 wherein the stowage container includes a visible side surface, and the visible side surface of the stowage container is flat.

11. The stowage container arrangement according to claim 1 wherein the receiving shape is formed by a recess of a vehicle door inner lining associated with a vehicle door.

12. The stowage container arrangement according to claim 1 incorporated into a central panel of a vehicle.

13. The stowage container arrangement according to claim 1 incorporated into a side lining of a vehicle.

14. The stowage container arrangement according to claim 2 wherein the undercut and the recess of the receiving shape are disposed in two oppositely-situated edge regions of the receiving shape.

15. The stowage container arrangement according to claim 3 wherein the undercut and the recess of the receiving shape are disposed in two oppositely-situated edge regions of the receiving shape.

16. The stowage container arrangement according to claim 2 wherein the stowage container and receiving shape form a form-fit.

17. The stowage container arrangement according to claim 3 wherein the stowage container and receiving shape form a form-fit.

18. The stowage container arrangement according to claim 4 wherein the stowage container and receiving shape form a form-fit.

19. The stowage container arrangement according to claim 14 wherein the stowage container and receiving shape form a form-fit.

20. The stowage container arrangement according to claim 15 wherein the stowage container and receiving shape form a form-fit.
